(19) United States
(12) Patent Application Publication
(10) Pub. No.: US 2018/0180122 A1
(43) Pub. Date: Jun. 28, 2018

(54) VEHICLE-USED BRAKE DISC COMPOSITE STRUCTURE

(71) Applicant: D.MAG (KUNSHAN) NEW MATERIAL TECHNOLOGY CO., LTD., Suzhou (CN)

(72) Inventor: Jibing Tu, Suzhou (CN)

(21) Appl. No.: 15/455,008

(22) Filed: Mar. 9, 2017

(30) Foreign Application Priority Data
Dec. 23, 2016 (CN) 201611203164.X

(51) Int. Cl. F16D 65/12

(52) U.S. Cl. CPC F16D 65/123; F16D 2065/1376; F16D 65/125

(57) ABSTRACT

A vehicle-used brake disc composite structure, comprising an inner ring piece made from a lightweight metal, and a disc body having a high rigidity, wear-resistance and heat-resistance; the inner ring piece is provided with a first engaging surface; an inner ring hole is disposed in the middle of the disc body; the disc body is provided with a second engaging surface, which is used to be fixed to the first engaging surface via welding method; the inner ring hole is covered by the inner ring piece; through fixing the inner ring piece to the disc body via welding method, the integral strength of the brake disc can be improved, and the functional life can be prolonged.

### TECHNICAL FIELD OF THE INVENTION

The present invention relates to the technical field of vehicles, and more particularly, to a vehicle-used brake disk composite structure.

### BACKGROUND OF THE INVENTION

To control the riding speed and braking of a bicycle, the braking device uses a rubber module to tightly press the bicycle rim to stop the bicycle. The traditional braking device has evolved into a disk brake device. In the prior art, the disk brake device usually adopts a flat brake disk which is mounted at one side of the hub of the bicycle rim. Consequently, the braking device can control the caliper to strongly rub against the brake disc to stop the bicycle without damaging the bicycle rim. However, the brake disc wears down quickly, requiring frequent replacement due to the abrasion of the caliper.

The brake disc made from stainless steel has a heavier weight, which affects the riding speed in a certain degree. To achieve a lightweight design, the traditional brake disc is usually made from aluminum alloy having a smaller density. Although aluminum alloy has a light weight, its rigidity is decreased accordingly. Furthermore, the fatigue performance of aluminum alloy is far lower than steel. A steel-made brake disc can bear an infinite cyclic load. However, the fatigue limit of aluminum alloy is near zero, meaning that a very small cyclic load can damage the brake disc made from aluminum alloy. Consequently, the functional life of the brake disc can be sharply decreased if the rigidity and the wear-resistance are not high enough.

### SUMMARY OF THE INVENTION

The purpose of the present invention is to solve the shortcomings in the prior art, and provide a vehicle-used brake disc composite structure.

To achieve the above purpose, the present invention adopts the following technical solution:

A vehicle-used brake disc composite structure, comprising an inner ring piece made from a lightweight metal and a disc body having high rigidity, wear-resistance and heat-resistance. The inner surface of the inner ring piece is equally divided and extends to form a plurality of fixing portions in the radial direction. The inner ring piece is provided with a first engaging surface. A plurality of holes is disposed on the surface of the disc body, and an inner ring hole is disposed in the middle of the disc body. The disc body is provided with a second engaging surface, which is used to be fixed to the first engaging surface via welding method. The inner ring hole is covered by the inner ring piece.

In another aspect of the present invention, the outer surface of the inner ring piece is the first engaging surface, and the inner surface of the inner ring hole of the disc body is the second engaging surface. The inner ring piece is fixed in the inner ring hole of the disc body, and the first engaging surface is fixed to the second engaging surface via welding method, enabling the inner ring piece and the disc body to stay in the same horizontal plane.

In another aspect of the present invention, the first engaging surface is disposed on one side surface of the inner ring piece near the disc body, and the second engaging surface is disposed on one side surface of the disc body near the inner ring piece. The inner ring piece uses the first engaging surface to fix onto the second engaging surface via welding method.

In another aspect of the present invention, the outer edge of the inner ring piece is provided with a protruding step structure. The outer surface of the protruding step structure is the first engaging surface. A first engaging portion, which is annular-shaped, is disposed on the first engaging surface along the radial direction. The fracture surface of the inner ring hole of the disc body is provided with a step structure, and the inner side surface of the step structure is the second engaging surface. A second engaging portion is disposed on the second engaging surface to correspond to the first engaging surface. The first engaging portion and the second engaging portion align with each other, enabling the first engaging surface and the second engaging surface to be fixed via welding method.

In another aspect of the present invention, the circumferential outer surface of the inner ring piece is the first engaging surface. The first engaging surface is equally divided and extends to form a plurality of the first locating portions. The circumferential inner surface of the inner ring hole of the disc body is the second engaging surface. A plurality of the second locating portions, which is inwardly-recessed, is disposed on the second engaging surface to correspond to the first locating portions. Through the engagement between the first locating portion and the second locating portion, the first engaging surface is tightly attached to the second engaging surface. The first engaging surface is fixed to the second engaging surface via welding method, and the first engaging portion is fixed to the second engaging portion via welding method, enabling the inner ring piece and the disc body to stay in the same horizontal plane.

Compared with the prior art, the present invention has the following advantages:

First, the present invention adopts an inner ring piece made from a lightweight metal and a disc body having high rigidity, wear-resistance and heat-resistance, effectively reducing the overall weight of the brake disc. The disc body which is in contact with the caliper is made from a material having high rigidity, wear-resistance and heat-resistance. Consequently, the rigidity of the point where the disc body is frequently rubbed with the caliper can be greatly improved, prolonging the functional life and reducing the replacement frequency of the brake disc.

Second, the inner ring piece is fixed to the disc body via welding method, enabling the inner ring piece to cover the inner ring hole of the disc body to improve the integral strength of the brake disc. Compared with the traditional dismountable structure of the inner ring piece and the disc body which may easily cause loosening, the present invention ensures a higher integral safety of the brake disc.

### BRIEF DESCRIPTION OF THE DRAWINGS

To clearly expound the present invention or technical solution, the drawings and embodiments are hereinafter combined to illustrate the present invention. Obviously, the drawings are merely some embodiments of the present invention and those skilled in the art can associate themselves with other drawings without paying creative labor.

FIG. 1 is a perspective view of the first embodiment of the present invention.

FIG. 2 is an exploded perspective view of the first embodiment of the present invention.

FIG. 3 is an assembled sectional view of the first embodiment of the present invention.

FIG. 4 is an exploded perspective view of the second embodiment of the present invention.

FIG. 5 is an assembled sectional view of the second embodiment of the present invention.

FIG. 6 is an exploded perspective view of the third embodiment of the present invention.

FIG. 7 is an assembled sectional view of the third embodiment of the present invention.

FIG. 8 is an exploded perspective view of the fourth embodiment of the present invention.

FIG. 9 is an assembled sectional view of the fourth embodiment of the present invention.

### DETAILED DESCRIPTION OF THE INVENTION

Drawings and detailed embodiments are combined hereinafter to elaborate the technical principles of the present invention.

### Embodiment 1

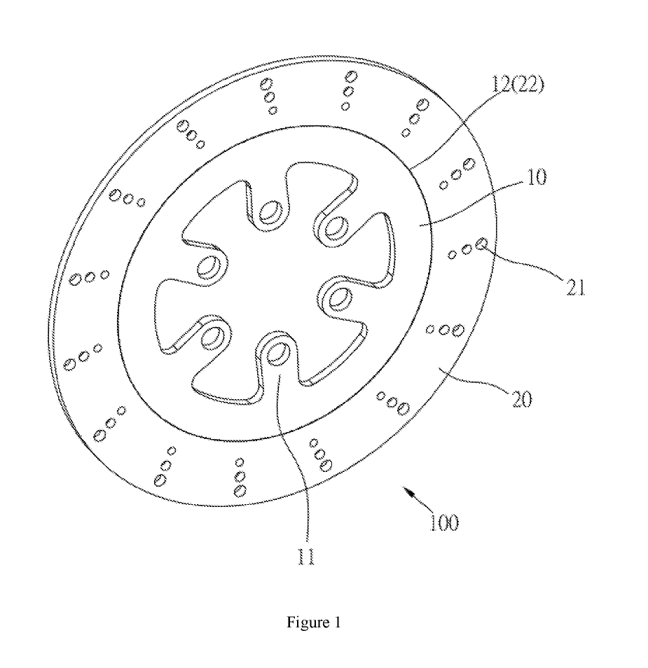

As shown in FIGS. 1-3, the brake disc 100 comprises an inner ring piece 10 and a disc body 20 which is mounted on the inner ring piece 10. The inner ring piece 10 is made from a lightweight metal, e.g., aluminum alloy, magnesium alloy, or titanium alloy. The inner surface of the inner ring piece 10 is equally divided and extends to form a plurality of arm-like fixing portions in the radial direction, through which the brake disc 100 can be fixed to the frame of the bicycle. The outer surface of the inner ring piece is the first engaging surface 12. The disc body 20 is made from a material having a high rigidity, heat-resistance and wear-resistance, e.g., stainless steel, heat-treated steel/iron, or metal coated with Teflon or other wear-resistant material, effectively improving the wear-resistance, rigidity and heat-resistance when the disc body 20 is rubbed with the caliper. Consequently, the functional life of the brake disc 100 can be prolonged. The disc body 20 is provided with a plurality of holes 21 for dissipating heat. An inner ring hole 211 is provided in the middle of the disc body 20. The inner surface of the inner ring hole 211 is the second engaging surface 22. During use, the inner ring piece 10 is mounted in the inner ring hole 211 of the disc body 20, enabling the first engaging surface 12 to be fixed to the second engaging surface 22 via friction welding method. The inner ring hole 211 of the disc body 20 is covered by the inner ring piece 10, enabling the inner ring piece 10 and the disc body 20 to stay in the same horizontal plane to form the brake disc 100.

### Embodiment 2

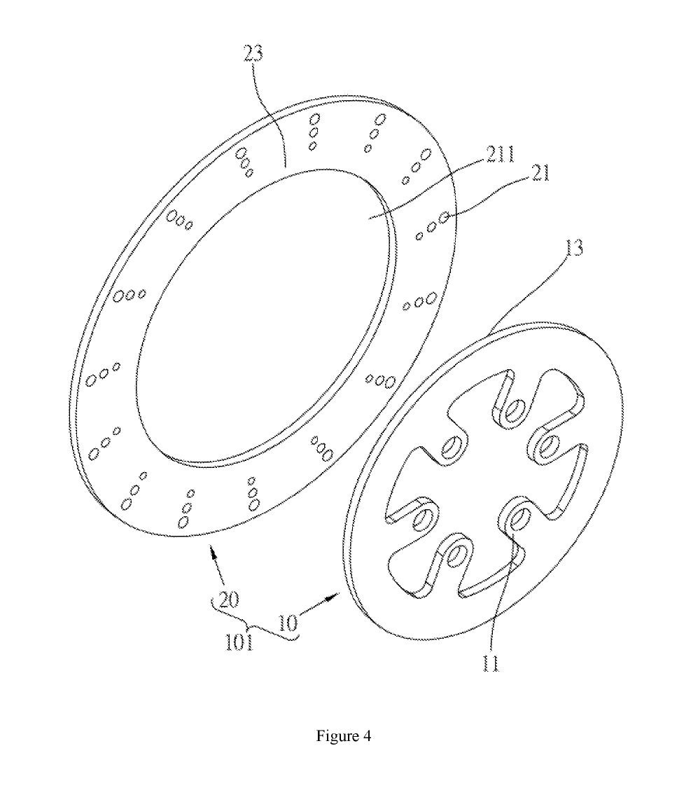

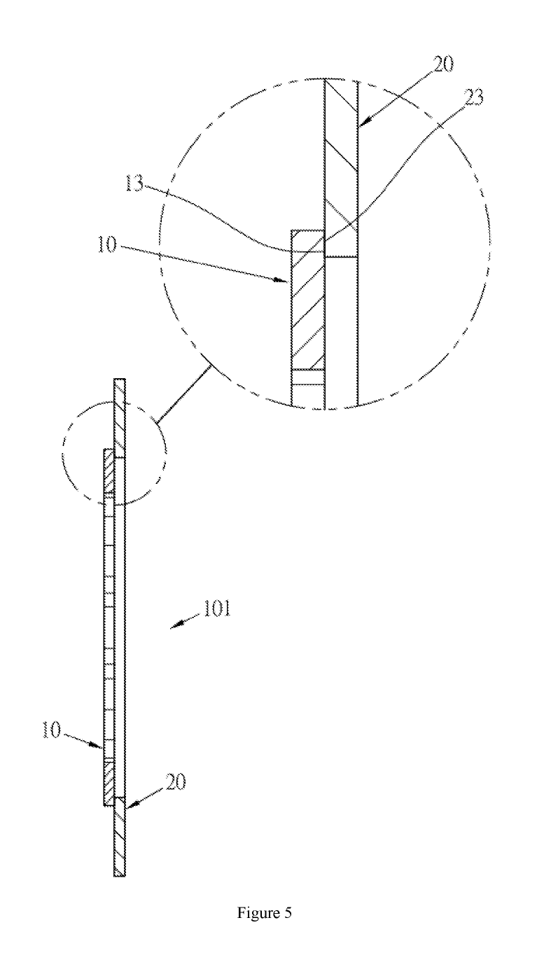

As shown in FIGS. 4-5, the first engaging surface 13 is disposed on one side surface of the inner ring piece 10 near the disc body 20 in the radial direction, and the second engaging surface 23 is disposed on one side surface of the disc body 20 near the inner ring piece 10 in the radial direction. Consequently, the first engaging surface 13 of the inner ring piece 10 is tightly attached to the second engaging surface 23 of the disc body 20, which are fixed via friction welding method to form the second type of brake disc 101 of the present invention.

### Embodiment 3

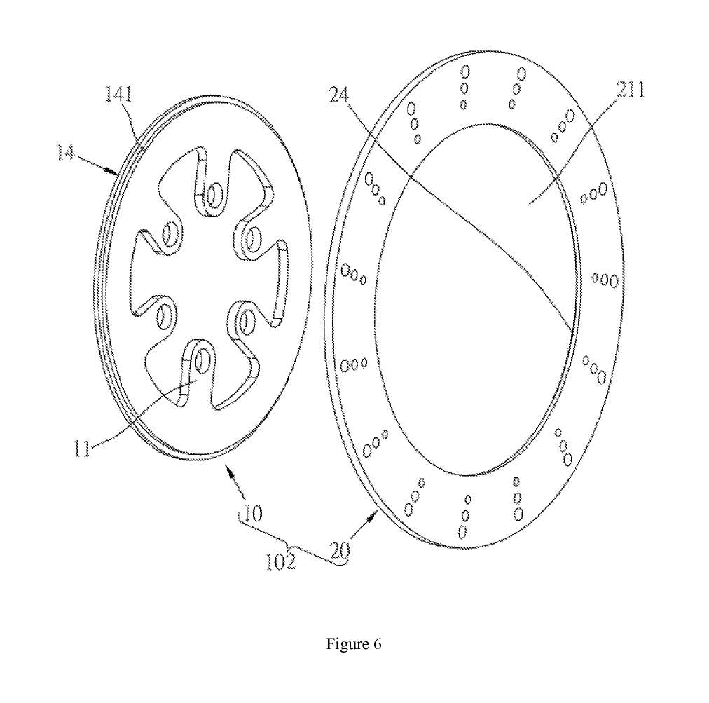

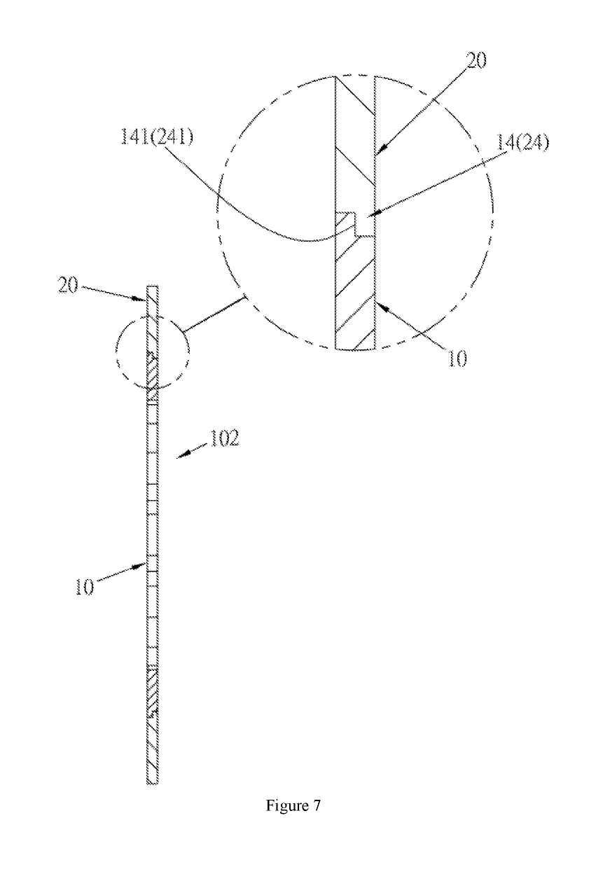

The third type of brake disc 102 is shown in FIGS. 6-7. The outer edge of the inner ring piece 10 is provided with a protruding step structure, and the outer surface of the protruding step structure is the first engaging surface 14. An annular-shaped first engaging portion 141 is disposed on the first engaging surface 14 in the radial direction. A step-like second engaging surface 24 is disposed on the fracture surface of the inner ring hole 211 of the disc body 20. An annular-shaped second engaging portion 241, which extends in the radial direction, is disposed on the second engaging surface 24 to correspond to the first engaging portion 141. The inner ring piece 10 uses the first engaging portion 141 to flatly abut on the second engaging portion 241, enabling the first engaging surface 14 to be completely engaged with the second engaging surface 24. Subsequently, the first engaging surface 14 is fixed to the second engaging surface 24 via friction welding method, and the inner ring piece 10 remains in the inner ring hole 211 of the disc body 20, thereby enabling the inner ring piece 10 and the disc body 20 to stay in the same horizontal plane. Meanwhile, through the engagement between the first engaging portion 141 and the second engaging portion 241, the locating precision between the inner ring piece 10 and the disc body 20 can be greatly improved, which increases the contact area and achieves a stable structure.

### Embodiment 4

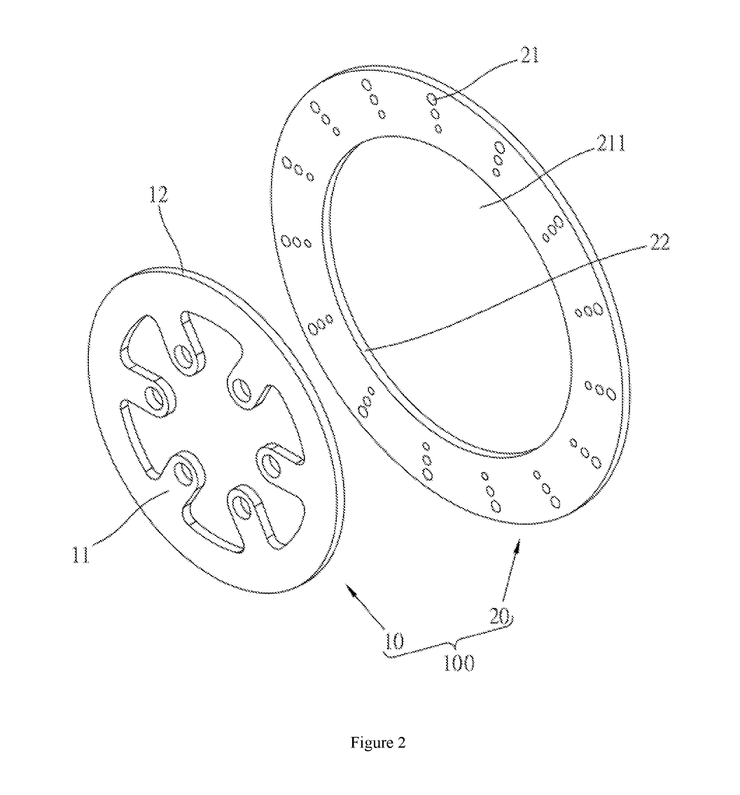

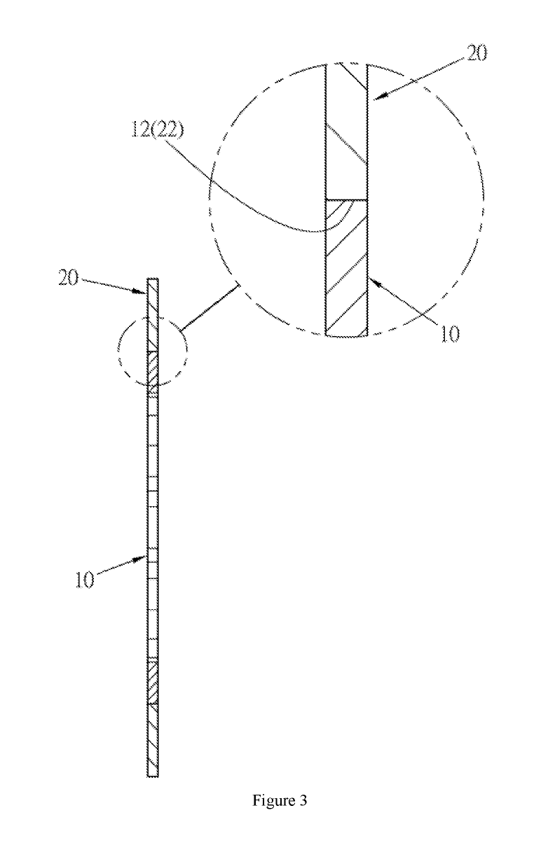

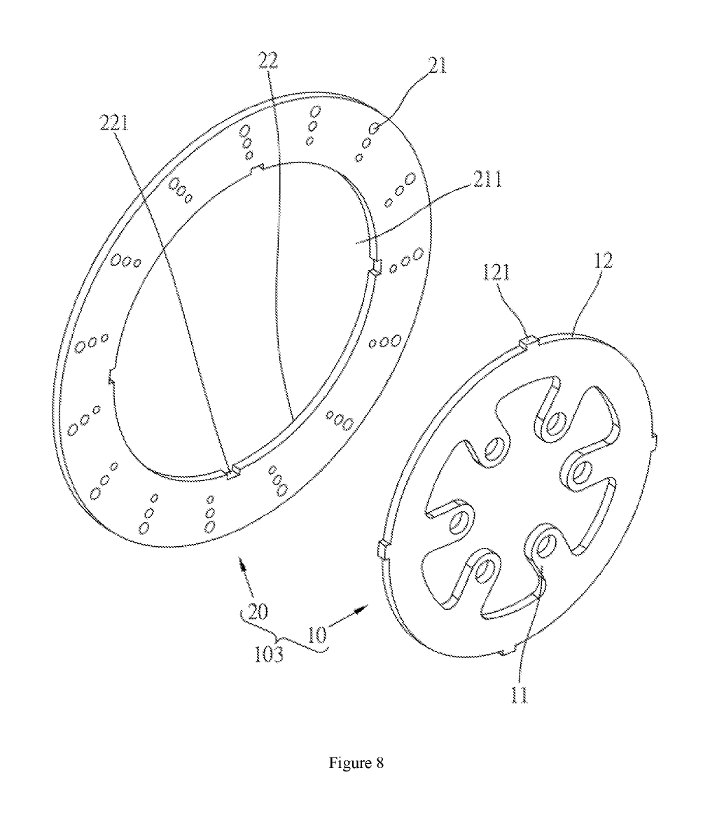

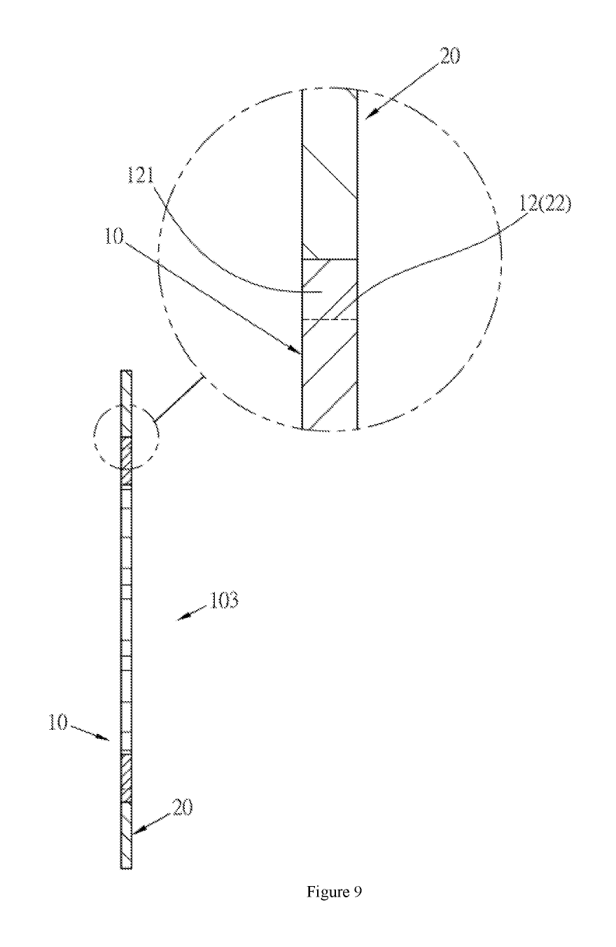

The fourth type of brake disc 103 is shown in FIGS. 8-9. Referring to FIGS. 2-3, the first engaging surface 12 is formed on the circumferential outer surface of the inner ring piece 10. The outer side of the first engaging surface 12 is equally divided and extends to form a plurality of the first locating portions 121. The second engaging surface 22 is formed on the circumferential inner surface of the inner ring hole 211 of the disc body 20. Differing from embodiment 1, an inwardly-recessed second locating portion 221 is formed on the second engaging surface 22 to correspond to the first locating portion 121 of the first engaging surface 12, ensuring that the first locating portion 121 is engaged with the second locating portion when the first engaging surface 12 enters into the disc body 20. Thus, the inner ring piece can smoothly enter into the inner ring hole 211 of the disc body 20, thereby forming the contact between first engaging surface 12 and the second engaging surface 22. The first engaging surface 12 is fixed to the second engaging surface 22 via friction welding, and the first locating portion 121 is fixed to the second locating portion 221 via friction welding, enabling the inner ring piece 10 and the disc body 20 to remain in the same horizontal plane. Under such circumstances, through the engagement between the first locating portion 121 and the second locating portion 221, the contact area can be increased and the twisting strength can be improved.

The previous descriptions are of preferred examples for implementing the invention, and the scope of the invention should not necessarily be limited by this description. The scope of the present invention is defined by the claims.

1. A vehicle-used brake disc composite structure, comprising:
an inner ring piece made from a lightweight metal, and
a disc body having high rigidity, wear-resistance and heat-resistance, wherein the inner surface of the inner ring piece is equally divided and extends to form a plurality of fixing portions in the radial direction, wherein the inner ring piece is provided with a first engaging surface, wherein a plurality of holes is disposed on the surface of the disc body, and an inner ring hole is disposed in the middle of the disc body, wherein the disc body is provided with a second engaging surface, wherein the first engaging surface is an outer surface of the inner ring piece, wherein the second engaging surface is an inner surface of the disc body, wherein the circumference of the first engaging surface equals to the circumference of the second engaging surface, wherein the second engaging surface is fixed directly to the first engaging surface via welding method, wherein there is no space between the first engaging surface and the second engaging surface.

2. The vehicle-used brake disc composite structure of claim 1, wherein the outer surface of the inner ring piece is the first engaging surface, and he inner surface of the inner ring hole of the disc body is the second engaging surface, wherein the inner ring piece is fixed in the inner ring hole of the disc body, and the first engaging surface is fixed to the second engaging surface via welding method, enabling the inner ring piece and the disc body to remain in the same horizontal plane.

3. (canceled)

4. The vehicle-used brake disc composite structure of claim 1, wherein the outer edge of the inner ring piece is provided with a protruding step structure, wherein the outer surface of the protruding step structure is the first engaging surface, wherein an annular-shaped first engaging portion is disposed on the first engaging surface along the radial direction, wherein the fracture surface of the inner ring hole of the disc body is provided with a step structure, and the inner side surface of the step structure is the second engaging surface, wherein a second engaging portion is disposed on the second engaging surface to correspond to the first engaging surface, wherein the first engaging portion and the second engaging portion align with each other, enabling the first engaging surface and the second engaging surface to be fixed via welding method.

5. The vehicle-used brake disc composite structure of claim 2, wherein the circumferential outer surface of the inner ring piece is the first engaging surface, wherein the first engaging surface is equally divided and extends to form a plurality of the first locating portions, wherein the circumferential inner surface of the inner ring hole of the disc body is the second engaging surface, wherein a plurality of the second locating portions, which is inwardly-recessed, is disposed on the second engaging surface to correspond to the first locating portions, wherein through the engagement between the first locating portion and the second locating portion, the first engaging surface is tightly attached to the second engaging surface, wherein the first engaging surface is fixed to the second engaging surface via welding method, and the first engaging portion is fixed to the second engaging portion via welding method, enabling the inner ring piece and the disc body to stay in the same horizontal plane.

6. A vehicle-used brake disc composite structure, comprising:
an inner ring piece made from a lightweight metal, and
a disc body having high rigidity, wear-resistance and heat-resistance,
wherein the inner surface of the inner ring piece is equally divided and extends to form a plurality of fixing portions in the radial direction, wherein the inner ring piece is provided with a first engaging surface, wherein a plurality of holes is disposed on the surface of the disc body, and an inner ring hole is disposed in the middle of the disc body, wherein the disc body is provided with a second engaging surface, wherein the length of the first engaging surface is longer than the length of the second engaging surface, wherein the second engaging surface is fixed directly to the first engaging surface via welding method, wherein the inner ring piece and the disc body are not on the same horizontal plane.
